(19) United States
(12) Patent Application Publication
(10) Pub. No.: US 2012/0028225 A1
(43) Pub. Date: Feb. 2, 2012

(54) Deli slices size selector

(75) Inventor: Bernard James Boswell, Ft. Worth, TX (US)

(73) Assignee: Bernard Boswell, Ft. Worth, TX (US)

(21) Appl. No.: 12/800,368

(22) Filed: Jul. 30, 2010

(51) Int. Cl. G09B 19/00

(52) U.S. Cl. 434/127

(57) ABSTRACT

The utility device for which the patent is applied for is a simple device. There are no mechanical moving parts.

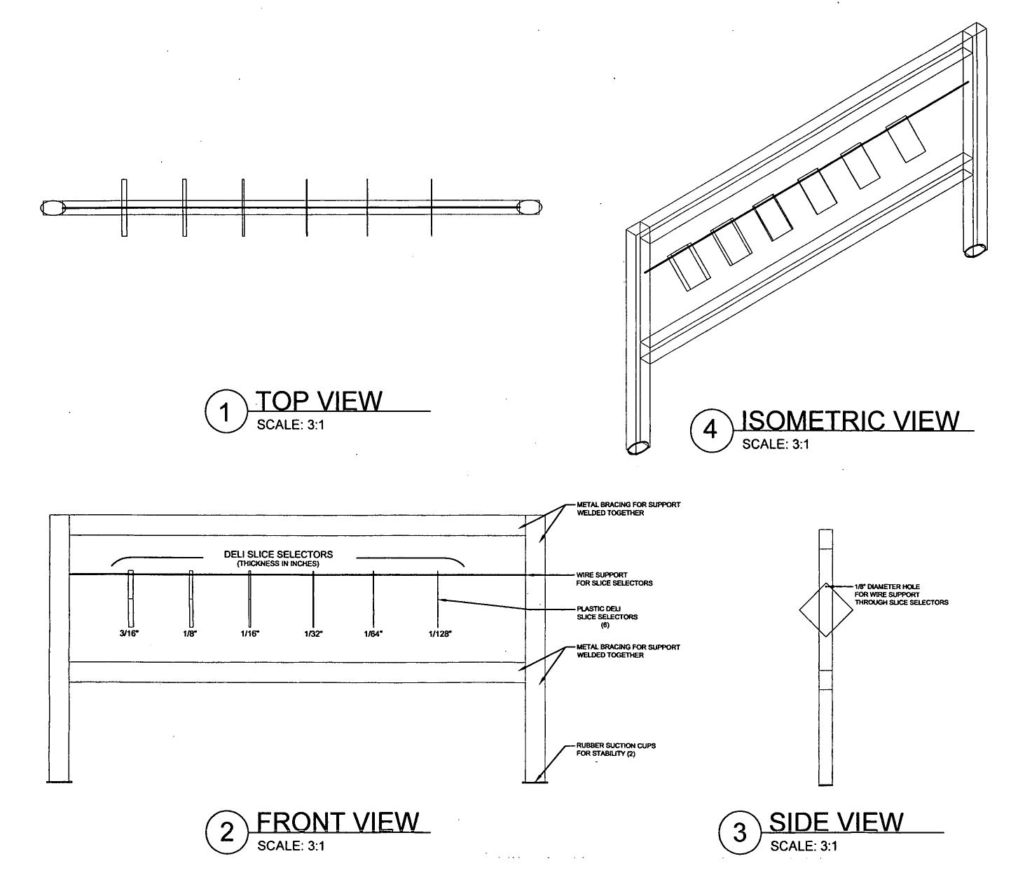

The device will sit on counter tops of stores and provide savings to the merchant by reducing/eliminating waste. It will provide the customer with an end to frustration and wasted time.

This invention is a utility device which will sit on the top of grocery store, sliced meat and cheese counters and anywhere where the customer wishes to indicate the thickness of sandwich meat to be sliced. The device will hold plastic squares the size of average meats and cheeses. The customer will indicate by pointing to or indicating a numbered, plastic square as to which thickness he would like his server to slice his selection.

The device will sit on the counter and be held in place by rubber suction “feet”.

The device will be made from lightweight, metal slats. It will have a rod from which toe plastic squares will hang down/“dangle” from . The squares will be numbered and placed in sequential thicknesses to help the customer show the server exactly how thick he would like his slices.

### BRIEF DESCRIPTION OF DRAWINGS

1. TOP VIEW—Scale 3:1 View is from the perspective of looking down on the device from directly above the device. View shows identical, support posts. Strung between the posts is a wire that will hold the different sizes of the plastic models representing the different slices which the customer will be able to select from.

2. FRONT VIEW—Scale 3:1 View is from the perspective of looking directly at the device as the deli customer will be looking at it. View shows identical, support posts. Strung between the posts is a wire that will hold the different sizes of the plastic models representing the different thicknesses which the customer will be able to select from.

3. SIDE VIEW—Scale 3:1 View is from the side perspective of the device. This view will show a single post and protruding, plastic models representing the different thicknesses which the customer will be able to select from.

4. ISOMETRIC VIEW—Scale 3:1 View is the 3 Dimensional view of the device.

1. I, Bernard Boswell, hereby wholly and rightfully claim full creative, conceptual and design ownership of the above mentioned device, being submitted for a patent.
